(19) United States
(12) Patent Application Publication
(10) Pub. No.: US 2025/0277947 A1
(43) Pub. Date: Sep. 4, 2025

(54) REPEATERED SUBMARINE OPTICAL CABLE

(71) Applicant: Prysmian S.p.A., Milano (IT)

(72) Inventor: Luca Giorgio Maria De Rai, Milano (IT)

(21) Appl. No.: 18/986,188

(22) Filed: Dec. 18, 2024

(30) Foreign Application Priority Data
Jan. 26, 2024 (IT) 102024000001500

(51) Int. Cl. G02B 6/44; H01B 7/14; H01B 7/22; H01B 7/282; H01B 11/22

(52) U.S. Cl. CPC G02B 6/4432; H01B 7/14; H01B 7/226; H01B 7/2825; H01B 11/22

(57) ABSTRACT

The present disclosure relates to a repeatered submarine optical cable comprising: one or more optical fibers; a metallic tubular buffer tube housing the one or more optical fibers; an electrically conductive layer surrounding the tubular buffer tube, and-at least one armor, wherein the at least one armor and/or the electrically conductive layer comprise carbon nanotube (CNT) bundles.

### CROSS-REFERENCE TO RELATED APPLICATIONS

This application claims the priority to Italian Application No. 102024000001500, filed on Jan. 26, 2024, which application is hereby incorporated herein by reference.

### TECHNICAL FIELD

The present disclosure relates to the field of telecommunication cables, particularly to a repeatered submarine optical cable, which can be deployed at high depths and for long lengths, e.g. in ocean floors.

### BACKGROUND

Optical cables for submarine applications should feature a high tensile strength and, at the same time, a light weight. Indeed, during installation and operation, a submarine optical cable should sustain high tensile loads when it hangs off of the installation vessel from the surface of the water to the seabed for many hundreds of meters with a consequent substantial tensile stress. Thus, submarine optical cables comprise one or more metallic armor layers, usually made of wound steel wires which increase the weight of the cable. As a consequence, in general the deeper the deployment site, the heavier the cable. On the other hand, the payoff system of the installation vessel has to be commensurate with the weight of the cable to be deployed. Hence, the heavier the cable is, the stronger the gripping force of the payoff system needs to be.

Additionally, submarine optical fiber cables, particularly developed for deep-sea transoceanic systems, suffer of attenuation which may be up to 0.25 dB/km or more. Thus, repeaters, generally placed every 50 km to 70 km, need to be used for optical signal amplification. Repeaters are fed by electric power which can be carried by the submarine optical cable. To this purpose, the repeatered submarine optical cable comprises an electric conductor, usually made of copper optionally joined to a semiconductive layer. FIG. 1 shows an example of a known repeatered submarine optical cable. This further increases the cable weight without substantially improving the tensile strength due to the poor mechanical properties of copper.

In order to reduce the overall cable weight while maintaining good mechanical properties at the same time, cables reinforced with aramid fibers have been proposed (see, for example U.S. Pat. No. 7,285,726).

The problem of providing electrically conductive cables with high tensile strength and light weight is common also in non-subsea applications. For example, WO 2015/162263 A1 discloses a hoisting member for an elevator system comprising a strength component comprising carbon nanotubes (CNTs) surrounded or embedded in a matrix material, e.g. epoxy resin or elastomer, creating a solid structure for the hoisting member. In some embodiments, the CNTs are configured to transmit electrical signals through hoisting member to provide power to an elevator car and/or to provide communication between a controller and the elevator car.

### SUMMARY

Embodiments of this application describe a repeatered submarine optical cable, capable of carrying electric power to optical repeaters, which has a high tensile strength and at the same time is sufficiently lightweight.

The Applicant has found that providing a repeatered submarine optical cable with carbon nanotube (CNT) bundles as strength components in substitution or in combination with metallic, e.g., made of steel, armor wires makes the cable lighter while maintaining high tensile strength. CNT bundles can be used also as electrically conductive components in substitution or in combination with a conductor, e.g., a copper layer optionally joined to a semiconductive layer, thereby eliminating or reducing the conductor thickness and weight.

In the present description and claims, a CNT bundle can be made of at least two CNT yarns twisted each other/s, each CNT yarn being made of a plurality of CNT filaments.

Accordingly, the present disclosure relates to a repeatered submarine optical cable comprising: one or more optical fibers; a metallic tubular buffer element housing the one or more optical fibers; an electrically conductive layer surrounding the tubular buffer element; and at least one armor, wherein the at least one armor and/or the electrically conductive layer comprise carbon nanotube (CNT) bundles.

According to the present disclosure the CNT bundles can act as strength members and/or as electric conductors depending on the position in the cable, as it will be shown in the following.

In an embodiment, the CNT bundles are in form of one or more bundles retained in tight configuration in a jacket.

In an embodiment, more bundles are retained adjacent and in direct contact one another in the jacket.

In an embodiment, the armor and the electrically conductive layer are a single layer comprising the CNT bundles.

In an embodiment, the single layer essentially consists of CNT bundles.

In an alternative embodiment, the armor comprises, helically wound around the buffer element, metallic armor wires and the CNT bundles.

In an embodiment, the electrically conductive layer comprises an electrically conductive element surrounding the armor and comprising the CNT bundles.

Optionally, the electrically conductive layer further comprises a swelling layer joined to the electrically conductive element.

In an embodiment, the repeatered submarine optical cable further comprises a protective sheath surrounding the electrically conductive layer and the armor.

In an embodiment, the repeatered submarine optical cable comprises an outer armor surrounding the protective sheath.

In an embodiment, the outer armor comprises one or more layers comprising a plurality of metallic, helically wound, armor wires.

In an alternative embodiment, the outer armor essentially consists of CNT bundles.

### BRIEF DESCRIPTION OF THE DRAWINGS

Further characteristics and advantages will be more apparent from the following description of some embodiments given as a way of an example with reference to the enclosed drawings in which:

FIG. 1 is a sectional view of a repeatered submarine optical cable according to the prior art;

FIGS. 2a and 2b are sectional views of CNT bundles of the repeatered submarine optical cable according to alternative embodiments;

FIG. 3 is a sectional view of the repeatered submarine optical cable according to an embodiment of the present disclosure;

FIG. 4 is a sectional view of the repeatered submarine optical cable according to another embodiment of the disclosure; and

FIG. 5 is a sectional view of the repeatered submarine optical cable according to another further embodiment of the disclosure; and

FIG. 6 is a sectional view of the repeatered submarine optical cable according to another further embodiment of the disclosure.

### DETAILED DESCRIPTION OF ILLUSTRATIVE EMBODIMENTS

For the purpose of the present description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

For the purpose of the present description and of the appended claims, the words “a” or “an” are used to describe elements and components of the invention. This is done merely for convenience and to give a general sense of the invention. In this description and claims should be read to include one or at least one and the singular also includes the plural unless it is obvious that it is meant otherwise.

The present disclosure, in at least one of the aforementioned aspects, can be implemented according to one or more of the following embodiments, optionally combined together.

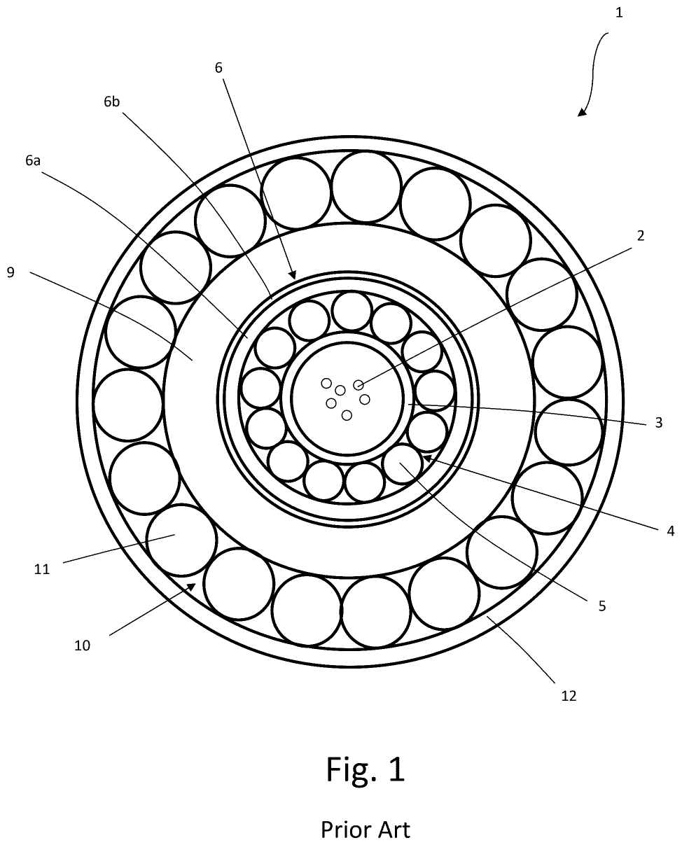

FIG. 1 shows a repeatered submarine optical cable 1 as known in the art. The cable 1 is adapted for submarine applications, e.g. it can be deployed on ocean floors, as discussed in the introductory part of the present description.

The cable 1 can comprise one or more optical fibers 2 bundled within a buffer tube 3 or buffer tube made of metal, e.g. of copper or steel, suitable to act as a water barrier. The buffer tube 3 can be manufactured by longitudinally welding, e.g. laser welding, a metal foil around the optical fibers 2. For the purposes of the present description, by “optical fiber” it is meant an optical core transmitting light surrounded by one or more protective layers.

The buffer tube 3 may also contain, in addition to the optical fibers 2, element/s capable of absorbing hydrogen, such as a gel or a thixotropic filling compound.

The cable 1 comprises an inner armor 4 surrounding and optionally in direct contact with the buffer tube 3. The inner armor 4 can be formed by a layer of metallic armor wires 5 helically wound. The armor wires 5 can be made of steel, e.g. of galvanized steel.

The cable 1 further comprises an electrically conductive layer 6 which surrounds and may be in direct contact with the inner armor 4. The electrically conductive layer 6 enables the feeding of electric power to optical repeaters (not shown) through the optical cable 1 itself. The electrically conductive layer 6 comprises an electrically conductive element 6a, e.g. made of copper. Additionally, the electrically conductive layer 6 may comprise a composite conductive element, where the electrically conductive element 6a is optionally joined to a semiconductive layer and/or a swelling layer 6b. The layer 6b can be in form of a woven or non-woven tape made of, for example, polyester fibers charged with carbon black and water absorbent powder.

A protective sheath 9 surrounds the electrically conductive layer 6, for example in direct contact thereto. For example, the protective sheath 9 is formed by extrusion of a polymeric material, for example HDPE (high-density polyethylene). The protective sheath 9 helps preventing the cable 1 from water ingress.

The cable 1 can also comprise an outer armor 10 surrounding the protective sheath 9, for example in direct contact with the same. The outer armor 10 can comprise one or more layers of metallic, e.g. steel, armor wires 11 helically wound.

The cable 1 can further comprise an outermost protective layer 12 around the outer armor 10, for example in direct contact with the same. The outermost protective layer 12 can comprise a sheath which may be formed by extrusion of a polymeric material, for example HDPE (high-density polyethylene). Alternatively, the outermost protective layer 12 comprises or essentially consists of polypropylene (PP) yarns. PP yarns may improve the handling performance.

The repeatered submarine optical cable of the present disclosure comprises carbon nanotube (CNT) bundles acting as strength members and/or as electric conductors (in combination with or in substitution of the electrically conductive element 6a), as will be described in more detail below.

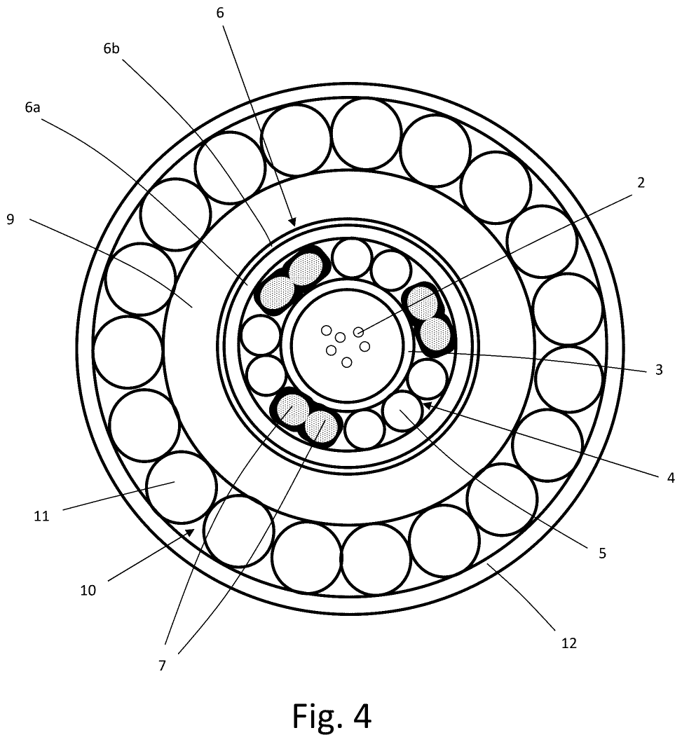

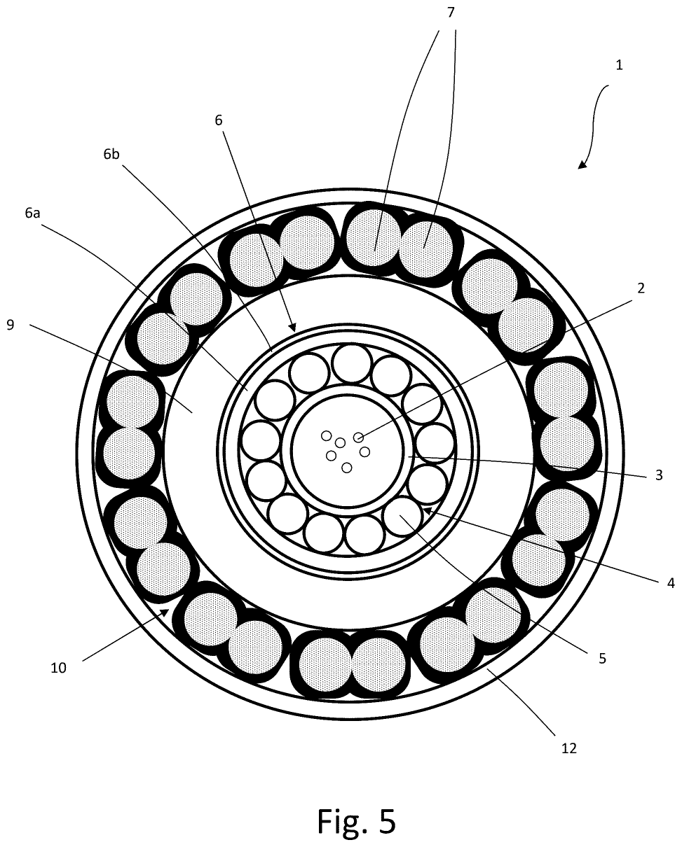

When the CNT bundles are intended to act as strength members, they can be present in the cable in combination with or in substitution of the metallic wires 5 and/or 11 of the inner armor 4 and/or of the outer armor 10. Two of these embodiments are shown in FIG. 4, where the inner armor 4 comprises armor wires 5 and CNT bundles 7, and in FIG. 5, where all the armor wires 11 of the outer armor 10 are substituted by CNT bundles 7.

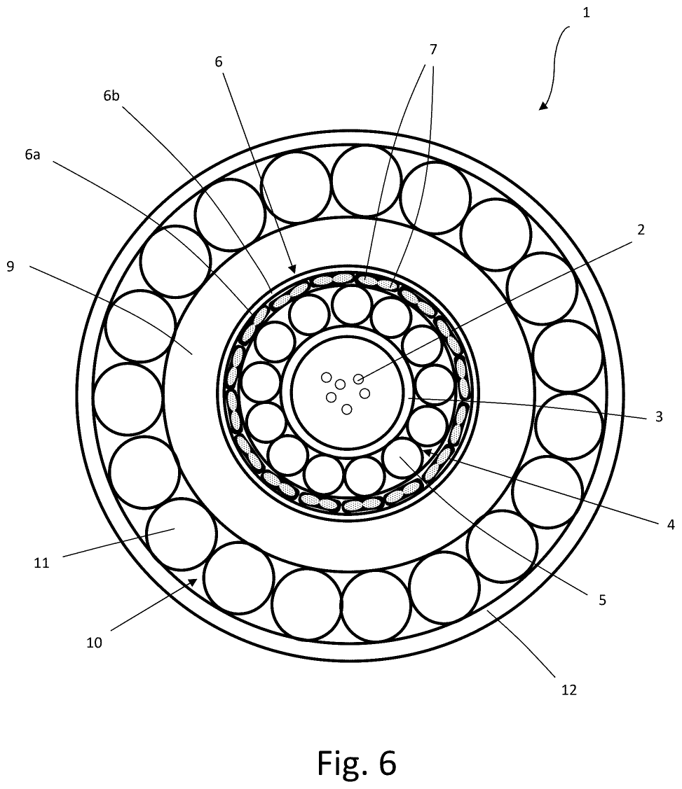

When the CNT bundles are intended to act as electric conductors, they can be present in combination with or in substitution of the electrically conductive element 6a. One of these embodiments is shown in FIG. 6, where the conductive element 6a is substituted by CNT bundles 7. In this case, the optional layer 6b can be omitted especially when it is solely semiconductive.

The CNT bundles can have a diameter comprised between 0.2 and 1 mm and be formed from CNT yarns having a diameter comprised between 10 and 100 μm (wherein each CNT yarn is formed of filaments having a diameter comprised between 2 to 20 nm).

The CNT bundles have a specific electric conductivity lower than that of copper (about 5,600 S·m/mm² vs 6,300 S·m/mm² for copper), while the CNT bundle tensile strength is greater than that of steel (5-70 GPa vs 0.4-1.55 GPa for steel). The mechanical performance of CNT bundles versus steel is even more outstanding considering the strength-to-weight ratio (specific strength) which is of greater than 40,000 versus a value of about 150 kN·m/kg for a high carbon steel.

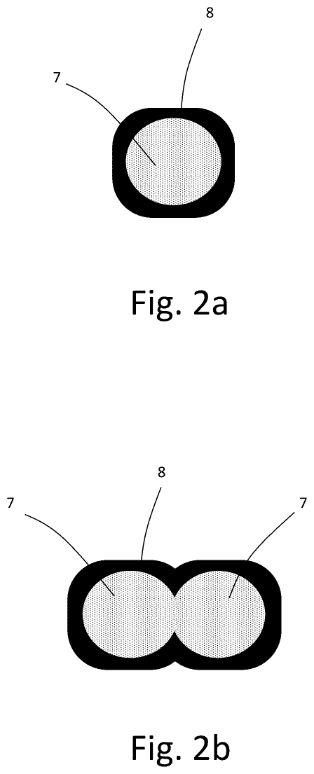

In an embodiment, as shown in FIGS. 2a and 2b, the CNT bundles are in form of one or more bundles 7 retained, in tight configuration, in a jacket 8. For example, a single jacket 8 may be configured for retaining a single CNT bundle 7 (FIG. 2a) or two CNT bundles 7 (FIG. 2b), for example retained adjacent and in direct contact one another. The jacket 8 is, for example, an extruded tube made, for example, of polyurethane or rubber—(EPR, NBR) based material, or of polyethylene or polypropylene.

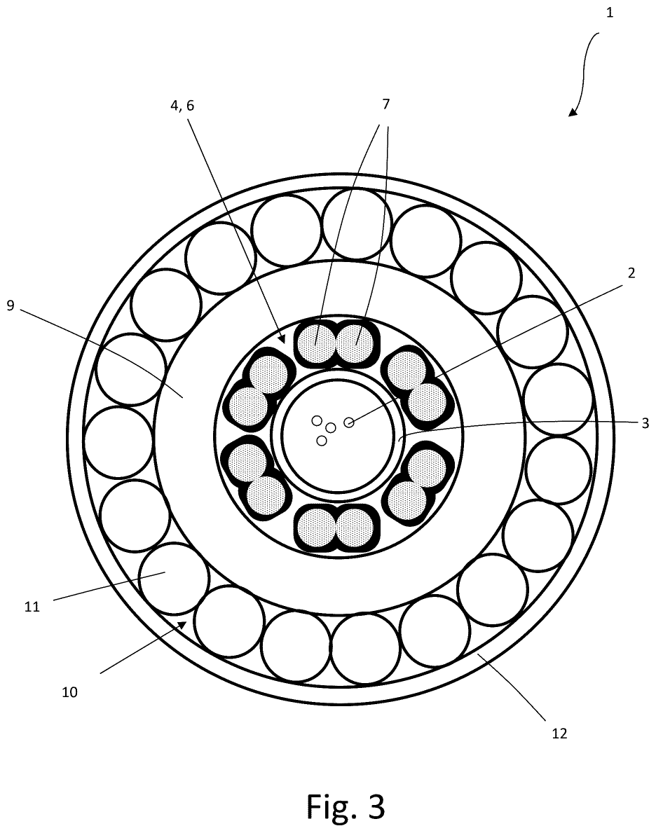

In the embodiment of FIG. 3, the inner armor 4 and the electrically conductive layer 6 are in form of a single layer 4,6 where CNT bundles provide both mechanical (tensile) strength and electric conductivity. The CNT bundles may be in form of yarn bundles 7 in jacket 8 as described in FIG. 2a or 2b. The CNT bundles are helically wound around the buffer tube 3, optionally in direct contact thereto. In this case the overall weight of the cable is reduced with respect to the cable of FIG. 1, as a single layer, lighter than a layer made of steel (the weight of the electrically conductive layer is negligible in front of that of an armor layer), can provide the cable with the sought electrical and mechanical performance.

In the embodiment of FIG. 4 the inner armor 4 comprises both a plurality of helically wound metallic armor wires 5 and CNT bundles, for example in form of yarn bundles 7 in jacket 8 as described in FIG. 2a or 2b, while the electrically conductive layer 6 is as described in connection to FIG. 1. In this case the overall weight of the cable is reduced with respect to the cable of FIG. 1.

In the embodiment of FIG. 5 the outer armor 10 is based on CNT bundles as strength members (in the place of the steel wires 11 of the known cable of FIG. 1). The CNT bundles may be in form of yarn bundles 7 in jacket 8 as described in FIG. 2a or 2b. The CNT bundles are helically wound around the protective sheath 9, optionally in direct contact thereto. In this case the weight of the cable is substantially reduced with respect to the cable of FIG. 1 for the reasons already mentioned above.

In the embodiment of FIG. 6 the electrically conductive layer 6 comprises CNT bundles in the place of the electrically conductive element 6a and, optionally the semiconductive layer 6b. The CNT bundles may be in form of yarn bundles 7 in jacket 8 as described in FIG. 2a or 2b. The CNT bundles are helically wound around the inner armor 4, optionally in direct contact thereto. In this case the CNT bundles act as the only electrical conductors. Accordingly, the quantity of metallic armor wires 5 and/or 11 or the number of layers in armor 4 and/or 10 can be reduced as an electrical conductor made of CNT is far less prone to tensile stress than one made of copper.

Additionally, the cables 1 of FIGS. 3-6 according to the present disclosure may comprise an outermost protective layer 12 essentially consisting of polypropylene (PP) yarns.

From the above follows that the CNT bundles can fully or partially act as tensile elements, as electrical conductors or as both tensile strength elements and electrical conductors. Depending on the desired cable properties in terms of weight, tensile strength, and electrical conductivity, the number of steel wires and/or the copper electrically conductive element 6a can be partially reduced or fully eliminated and substituted with a proper amount of CNT bundles having equivalent mechanic and/or electric properties.

In the following, a comparative known cable (having a structure like that of FIG. 1, but with an outer armor 10 comprising two layers of steel wires 11) and the cable of FIG. 3 according to the present disclosure, where the inner armor and the electric conductor are made of CNT bundles, are compared in term of dimension and weight.

Taking into account that the buffer tubes 3 of the two cables have the same diameter (4.4 mm), the electric conductor 6 of the comparative cable has a diameter of 9.0 mm, while in the cable of FIG. 3 the layer 4,6 of CNT bundles acting as the inner armor layer and the electrically conductive layer has a diameter of 13 mm. The weight of the inner armor 4+the electrically conductive layer 6a of the comparative cable is 328 kg/km, while the weight of the layer 4,6 of CNT bundles is of 240 kg/km.

The protective sheath 9 of the comparative cable has an outer diameter of 17 mm and weighs 52 kg/km, while the protective sheath 9 of the cable of FIG. 3 has an outer diameter of 21 mm and weighs 199 kg/km due to the greater diameter of the underlying CNT layer 4,6.

The diameter of the outer armor 10 of the comparative cable (comprising two layers of steel wires 11) is of 27.4 mm. Thanks to the greater tensile strength of the CNT bundles present as inner armor 4 (and electric conductor 6) with respect to the steel wires, in the cable of FIG. 3 the outer armor 10 made of a single layer of steel wires 11 is suitable to bear the cable weight, such single layered outer armor 10 having a diameter of 26.2 mm. The weight of the double layered outer armor 10 of the comparative cable is 2,145 kg/km, while the weight of the single layered outer armor 10 of the present cable is 1,200 kg/km.

The outermost protective layer 12 of the comparative cable has an outer diameter of 34.2 mm and weighs 230 kg/km, while the outermost protective layer 12 of the cable of FIG. 3 has an outer diameter of 33 mm and weighs 221 kg/km thanks to the smaller diameter of the underlying outer armor 10.

Adding to the weights above mentioned for the two cables the weight of the buffer tube 3 (45 kg/km), the total weight of the comparative cable is 2,908 kg/km, while the total weight of the cable of FIG. 3 is 1,906 kg/km.

Compared to a known cable, a cable according to the present disclosure has smaller diameter and has almost half the weight.

It is further observed that steel and copper manufacturing is responsible of a big amount of global CO₂ emissions, whereas CNTs can be made from hydrocarbons, capturing carbon and co-producing hydrogen. Accordingly, the repeatered submarine optical cable of the present disclosure is more sustainable than repeatered submarine optical cables according to the known art because the amount of steel and copper can be reduced.

What is claimed is:

1. An optical cable comprising:
one or more optical fibers;
a metallic buffer tube housing the one or more optical fibers;
an electrically conductive layer surrounding the buffer tube; and
at least one armor, wherein the at least one armor comprises carbon nanotube (CNT) bundles.

2. The optical cable of claim 1, wherein the CNT bundles are in form of one or more bundles retained in tight configuration in a jacket.

3. The optical cable of claim 2, wherein the one or more bundles are retained adjacent and in direct contact with one another in the jacket.

4. The optical cable of claim 1, wherein the armor and the electrically conductive layer are a single layer comprising the CNT bundles.

5. The optical cable of claim 4, wherein the CNT bundles constitute a majority component of the single layer.

6. The optical cable of claim 4, wherein the armor comprises metallic armor wires and the CNT bundles, and wherein the armor wires and the CNT bundles are helically wound around the buffer tube.

7. The optical cable of claim 1, wherein the electrically conductive layer comprises electrically conductive CNT bundles surrounding the armor.

8. The optical cable of claim 7, wherein the electrically conductive layer further comprises a swelling layer joined to the electrically conductive CNT bundles.

9. The optical cable of claim 1, further comprising a protective sheath surrounding the electrically conductive layer and the armor.

10. The optical cable of claim 9, further comprising an outer armor surrounding the protective sheath.

11. The optical cable of claim 10, wherein the outer armor comprises one or more layers comprising a plurality of metallic, helically wound, armor wires.

12. The optical cable of claim 10, wherein the outer armor is made of CNT bundles.

13. An optical cable comprising:
one or more optical fibers;
a metallic buffer tube housing the one or more optical fibers;
an electrically conductive layer surrounding the buffer tube; and
at least one armor, wherein the electrically conductive layer comprises carbon nanotube (CNT) bundles.

14. The optical cable of claim 13, wherein the CNT bundles are in form of one or more bundles retained in tight configuration in a jacket.

15. The optical cable of claim 14, wherein the one or more bundles are retained adjacent and in direct contact with one another in the jacket.

16. The optical cable of claim 13, wherein the armor and the electrically conductive layer are a single layer comprising the CNT bundles.

17. The optical cable of claim 16, wherein the armor comprises metallic armor wires and the CNT bundles, and wherein the armor wires and the CNT bundles are helically wound around the buffer tube.

18. The optical cable of claim 13, wherein the electrically conductive layer comprises electrically conductive CNT bundles surrounding the armor, wherein the electrically conductive layer further comprises a swelling layer joined to the electrically conductive CNT bundles.

19. An optical cable comprising:
one or more optical fibers;
a metallic buffer tube housing the one or more optical fibers;
an electrically conductive layer surrounding the buffer tube; and
at least one armor, wherein the at least one armor and the electrically conductive layer comprise carbon nanotube (CNT) bundles.

20. The optical cable of claim 19, further comprising
a protective sheath surrounding the electrically conductive layer and the armor; and
an outer armor surrounding the protective sheath, wherein the outer armor comprises one or more layers comprising a plurality of metallic, helically wound, armor wires, and wherein the outer armor is made of CNT bundles.
